(19) United States
(12) Patent Application Publication
(10) Pub. No.: US 2026/0024256 A1
(43) Pub. Date: Jan. 22, 2026

(54) METHOD FOR EDITING PERFORMERS IN VIDEO USING VIRTUAL HUMAN

(71) Applicant: 5MOTION INC., Seoul (KR)

(72) Inventor: Hyunmee CHOI, Seoul (KR)

(21) Appl. No.: 19/271,813

(22) Filed: Jul. 17, 2025

(30) Foreign Application Priority Data
Jul. 19, 2024 (KR) 10-2024-0095651

(51) Int. Cl. G06T 11/60; G06T 7/70

(52) U.S. Cl. CPC G06T 11/60; G06T 7/70

(57) ABSTRACT

A method for editing performers in a video using a virtual human includes: (a) selecting frames including a source human object by searching for a 2D video composed of a plurality of frames; (b) generating a face sequence by tracking a face of the source human object; (c) finding a depth of each object, and determining whether a corresponding object is located in front of or rear of the source human object; (d) selecting a 3D face template, and generating a 3D face of a target human object by reflecting a 2D face of the target human object; (f) estimating pose information, generating a 3D virtual human of the target human object by reflecting the pose information, and synthesizing the 3D face of the target human object with a face portion of the 3D virtual human; and (i) synthesizing the 3D virtual human into a 2D video image space.

### BACKGROUND OF THE INVENTION

### 1. Field of the Invention

The present invention relates to a method for editing performers in a video using a virtual human, which separates a human object such as a performer from two-dimensional (2D) video data, edits the human object into a desired form using a three-dimensional (3D) virtual human template, projects the edited 3D virtual human onto the 2D video data, and synthesizes the 3D virtual human to edit the performer in a 2D video.

### 2. Description of the Related Art

In general, technologies such as 2D image analysis, tracking, and real-time animation are being applied to synthesize a virtual 3D face in live-action broadcasting and video content. However, when the technologies are reaching their limitation when applied to high-quality real-time service solutions. That is, there is no high-quality broadcasting that guarantees a minimum delay and real and virtual synthesis technologies that may be applied to video content. When a virtual 3D model is synthesized by tracking a 3D face motion in a live-action video, it is impossible to apply a medium requiring high quality due to deterioration of the quality of the result.

A real-time face synthesis solution that is indistinguishable by a person is required to overcome the limitation of the synthesis technologies for video content. However, the conventional 3D digital human technology is difficult to apply in industrial sites due to the high production cost and the awkwardness of animation. Therefore, although the synthesis technology of real and virtual objects is used, there is still awkwardness due to the absence of a spatial optimization solution such as lighting mismatch.

Thus, there is a need for a method for editing next-generation broadcasting and video content focusing on people. In other words, there is a need for a technology capable of editing and reprocessing content by synthesizing a 3D digital human, which is produced to enable animation in live-action broadcasting and video content produced in various environments, with high quality in real time.

As the costs of modeling, rigging, costumes, and simulations increase to create a full body into a 3D digital human, a demand for synthesis of a real body and a virtual face is being increased as a solution to overcome the cost increase. There is a need for a technology that may synthesize and edit a video that is indistinguishable by a person at a high speed by synthesizing an ultra-realistic 3D digital human face with natural movement in a live-action video including a person.

### RELATED ART DOCUMENT

### Non-Patent Documents

(Non-Patent Document 1) YoLo, “Real-Time Object Dectection”, https://pjreddie.com/darknet/yolo/
(Non-Patent Document 2) https://github.com/serengil/retinaface
(Non-Patent Document 3) https://arxiv.org/abs/2207.10941
(Non-Patent Document 4) https://github.com/abewley/sort
(Non-Patent Document 5) https://arxiv.org/abs/1801.07698
(Non-Patent Document 6) https://gaussian37.github.io/vision-concept-optical_flow
(Non-Patent Document 7) https://blog.naver.com/dldlsrb45/220879295400
(Non-Patent Document 8) https://aashishrai3799.github.io/Towards-Realistic-Generative-3D-Face-Models/
(Non-Patent Document 9) https://keentools.io/products/facebuilder-for-blender
(Non-Patent Document 10) https://blog.naver.com/podo_hyoni/223146656529
(Non-Patent Document 11) https://paperswithcode.com/paper/cm-gan-image-inpainting-with-cascaded
(Non-Patent Document 12) https://sanghoon23.tistory.com/81

### SUMMARY OF THE INVENTION

To solve the above-described problem, an object of the present invention is to provide a method for editing performers in a video using a virtual human, which separates a human object such as a performer from 2D video data, edits the human object onto a desired form using a 3D virtual human template, projects the edited 3D virtual human into the 2D video data, and synthesizes the 3D virtual human to edit the performer in a 2D video.

To achieve the above object, the present invention relates to a method for editing performers in a video using a virtual human includes: (a) selecting frames including a person of a human object to be edited (hereinafter referred to as a source human object) by searching for a 2D video composed of a plurality of consecutive frames in frame units; (b) generating a face sequence of the source human object by tracking a face of the source human object in the selected frames; (c) finding a depth of each object existing in a corresponding frame by generating a depth map, and determining whether a corresponding object is located in front of or behind the source human object; (d) selecting a 3D face template for the face of the source human object, and generating a 3D face of a target human object by reflecting a 2D face of the target human object in the selected 3D face template; (f) estimating pose information from the source human object for each of the selected frames, generating a 3D virtual human of the target human object by reflecting the pose information in a preset 3D body template, and synthesizing the 3D face of the target human object with a face portion of the 3D virtual human of the target human object; and (i) synthesizing the 3D virtual human of the target human object into a 2D video image space of the corresponding frame.

In addition, in the method for editing the performers in the video using the virtual human, in step (b), for consecutive frames, the face of the source human object may be recognized and tracked within a certain range of a face position of previous and subsequent frames.

In addition, in the method for editing the performers in the video using the virtual human, in step (c), the object separated according to the depth may be composed of a background object located at a rearmost side, a source human object that is an editing target, and a general object that is neither the background object nor the source human object, and in step (i), each separated object may be synthesized into the 2D video space, in which the separated object is sequentially synthesized into the 2D video space from an object that is located at the rearmost side according to a front-rear positional relationship, and when the separated object is the general object, the general object may be synthesized into the 2D video space as it is, and when the separated object is the source human object, a virtual human of a target human object corresponding to the source human object may be synthesized into the 2D video space.

In addition, in the method for editing the performers in the video using the virtual human, in step (c), all general objects located behind a human object that is located at the rearmost side among source human objects of the editing target may be integrated into the background object.

In addition, the method for editing the performers in the video using the virtual human may further include (h) correcting a separated background object in association with a region of the separated object, in which, in step (i), when each separated object is synthesized into the 2D video space, the corrected background may be synthesized instead of the separated background object, and may be primarily synthesized into the 2D video space.

In addition, in the method for editing the performers in the video using the virtual human, in step (d), a 3D face template corresponding to the face of the source human object may be selected, a 3D face of the target human object may be generated by reflecting the 2D face of the target human object in the 3D face template, and a position and a direction of the 3D face of the target human object may be synchronized with a size, a position, and a direction of the 2D face of the source human object.

In addition, in the method for editing the performers in the video using the virtual human, in step (d), the 3D face of the target human object and the 2D face of the source human object may be synchronized to coincide with each other in terms of the position and the direction using landmarks including at least one of area around eyes, an area around a mouth, a jawline, and a nose line.

In addition, the method for editing the performers in the video using the virtual human may further include (e) estimating lighting information including a light source position and a lighting intensity with respect to each of the selected frames, in which, in step (i), an outer appearance of the 3D virtual human of the target human object may be rendered by reflecting the estimated lighting information, and the rendered 3D virtual human may be synthesized by projecting the rendered 3D virtual human onto a 2D plane.

In addition, in the method for editing the performers in the video using the virtual human, in step (f), the 3D virtual human of the target human object may be generated from a 2D image of a corresponding frame of the 2D video, in which the 3D virtual human of the target human object may be generated using a skinned multi-person linear model-eXpretive (SMPL-X) deep learning model, and pose information and an outer appearance of the 3D virtual human may be extracted.

In addition, the method for editing the performers in the video using the virtual human may further include (g) animating a 3D virtual human of the target human object according to a preset pose sequence for sections of frames k+1 to k+n to generate a 3D virtual human of each frame, and rigging the 3D virtual human of a frame k and reflecting and the pose sequence in the rigged 3D virtual human to animate the 3D virtual human, in which, in step (i), the 3D virtual human generated by animating in step (g) may be synthesized into a 2D video space.

In addition, in the method for editing the performers in the video using the virtual human, in step (g), when the virtual human of the target model is rigged, pose data of the SMPL-X model may be used, and the 3D virtual human may be animated by reflecting a sequence of 3D poses using motion retargeting.

In addition, the present invention relates to a computer-readable recording medium having a program recorded thereon for executing the method for editing the performers in the video using the virtual human.

As described above, according to the method for editing performers in a video using a virtual human according to the present invention, a human object may be separated from 2D video data and edited into a 3D virtual human, and the 3D virtual human may be projected onto a 2D video and synthesized, thereby expressing a more natural face and facial expression and editing a body motion.

That is, the present invention may overcome the quality deterioration by generating a natural facial expression and a mouth shape using a generative AI for the occurrence of quality deterioration due to unnatural face animation and facial expression synthesis.

In addition, the present invention may apply a parallelization solution to overcome the difficulty of high-speed according to analysis of facial expressions, animations, lighting, and the like during synthesis.

In addition, the present invention may maintain a real-time speed in a low latency for natural synthesis of a live-action level that may be used in YouTube broadcasting for scalability of a business model. This minimizes manual post-processing, so that human costs and post-processing time are minimized, thereby enabling the planning of a highly competitive business model. In particular, even a result generated only by an automation technology may provide a service in some commercial content media such as TV, OTT, TikTok, and YouTube.

### BRIEF DESCRIPTION OF THE DRAWINGS

FIG. 1A and FIG. 1B are exemplary diagrams of a configuration of an overall system for carrying out the present invention.

FIG. 2 is a flowchart explaining a method for editing performers in a video using a virtual human according to one embodiment of the present invention.

FIG. 3A is a diagram illustrating a process of the method for editing performers in a video using a virtual human according to one embodiment of the present invention. FIG. 3B to 3E are enlarged views showing portions of FIG. 3A

FIG. 4 is a flowchart explaining a detailed process for a step of recognizing and tracking a face according to one embodiment of the present invention.

FIG. 5 is a diagram illustrating a process of mapping each frame of the 2D video to a 3D space according to one embodiment of the present invention.

FIG. 6 is a diagram illustrating a process of generating a face for conversion from a result of separating a face of an editing target according to one embodiment of the present invention.

FIG. 7 is a diagram illustrating a process of generating a virtual human according to one embodiment of the present invention.

### DETAILED DESCRIPTION OF THE INVENTION

Hereinafter, specific details for carrying out the present invention will be described below with reference to the accompanying drawings.

In the description of the present invention, the same elements are denoted by the same reference numerals and will not be repeatedly described.

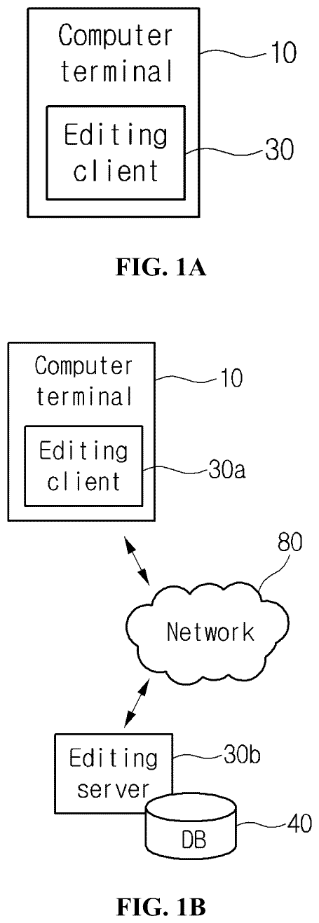

First, examples of a configuration of the entire system for carrying out the present invention will be described with reference to FIG. 1A and FIG. 1B.

As illustrated in FIG. 1A, a method for editing performers in a video using a virtual human (hereinafter referred to as an editing method) according to the present invention may be implemented by a program system on a computer terminal 10 that receives the 2D video to edit a director object.

That is, the editing method may be implemented by a program system 30 on the computer terminal 10, such as a PC, a smartphone, or a tablet PC. In particular, the editing method may be implemented by the program system, which may be installed in the computer terminal 10 and executed. The editing method provides a service for receiving the 2D video to edit the director object by using hardware or software resources of the computer terminal 10.

In addition, as another embodiment, as illustrated in FIG. 1B, the editing method may be executed by a server-client system including an editing client 30a and an editing server 30b on the computer terminal 10.

Meanwhile, the editing client 30a and the editing server 30b may be implemented according to a method for configuring a typical client server. That is, the functions of the overall system may be shared according to performance of the client or an amount of communication with the server. Hereinafter, an editing system will be described, but may be implemented in various forms according to the method for configuring a server-client.

Meanwhile, as another embodiment, the editing method may be implemented by one electronic circuit such as an application-specific integrated circuit (ASIC) in addition to being implemented by a program to operate in a general-purpose computer. Alternatively, the editing method may be developed using a dedicated computer terminal that only processes editing of the director object by receiving the 2D video. Other possible forms may also be implemented.

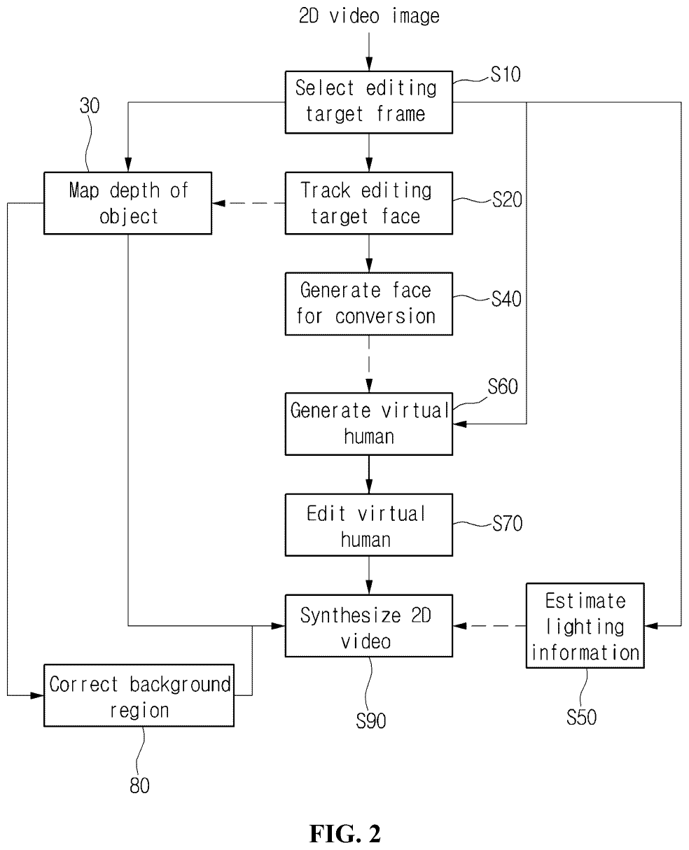

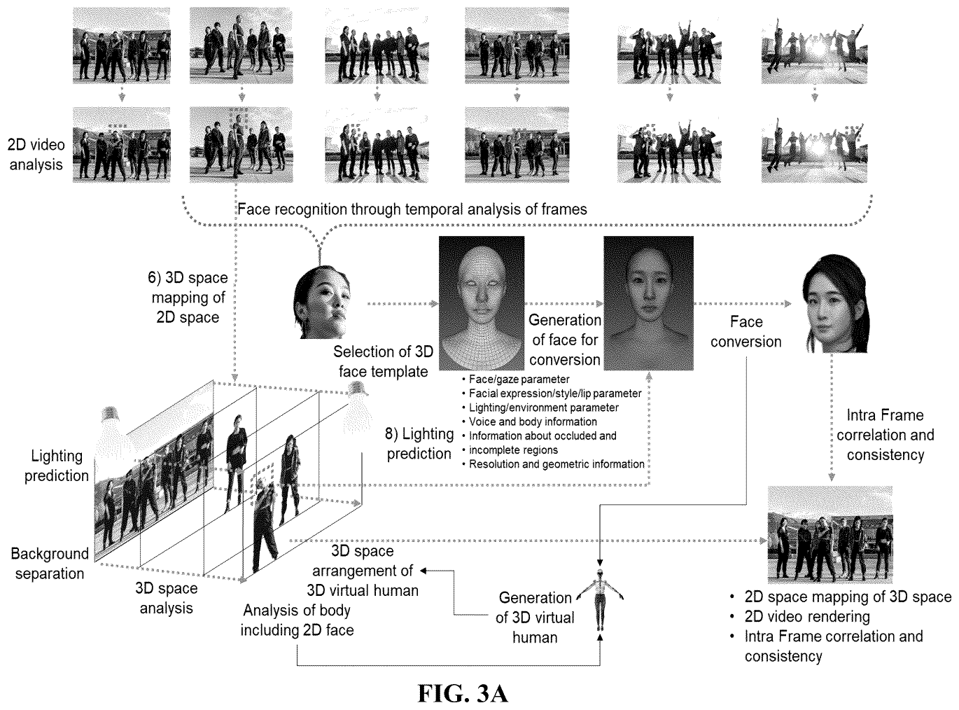

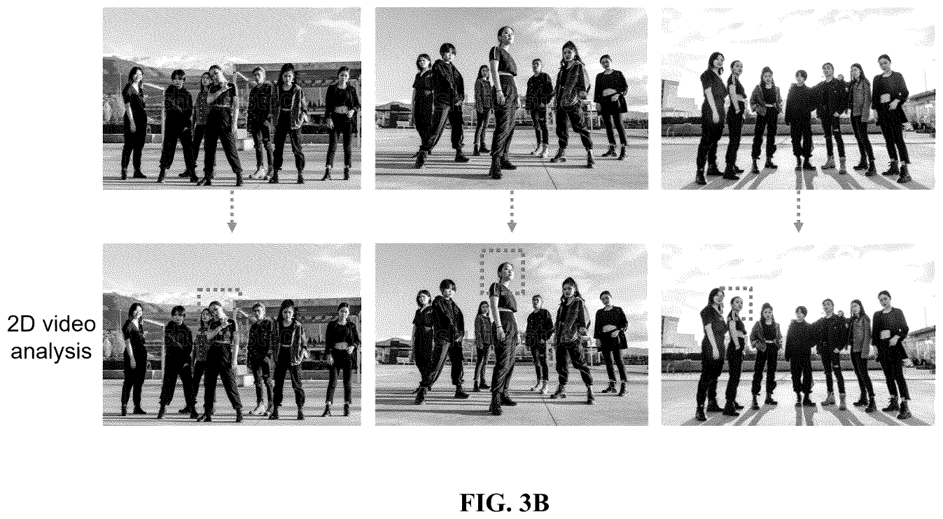

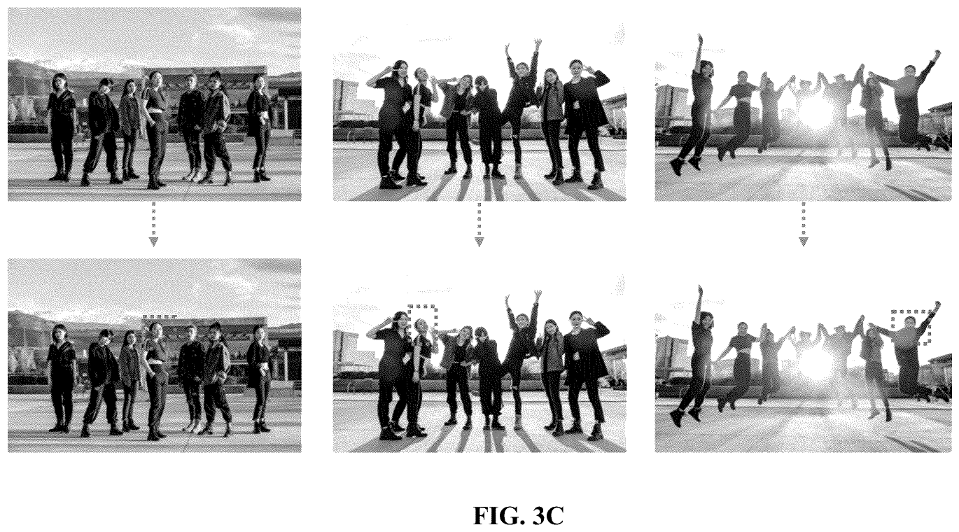

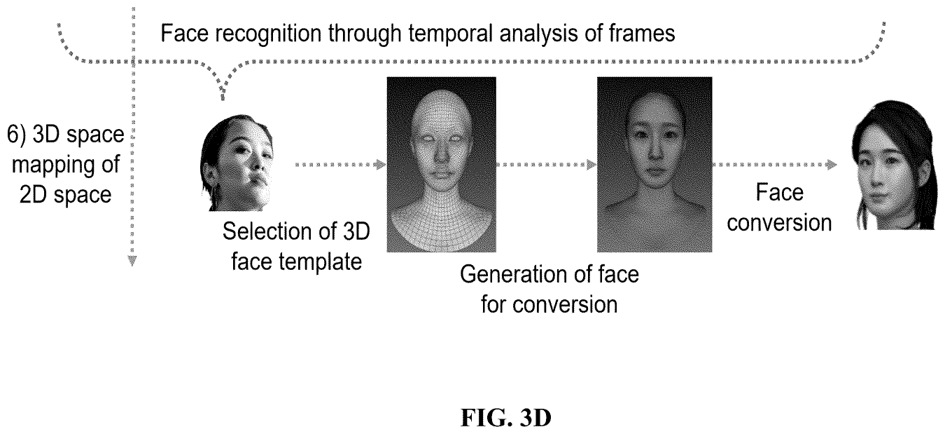

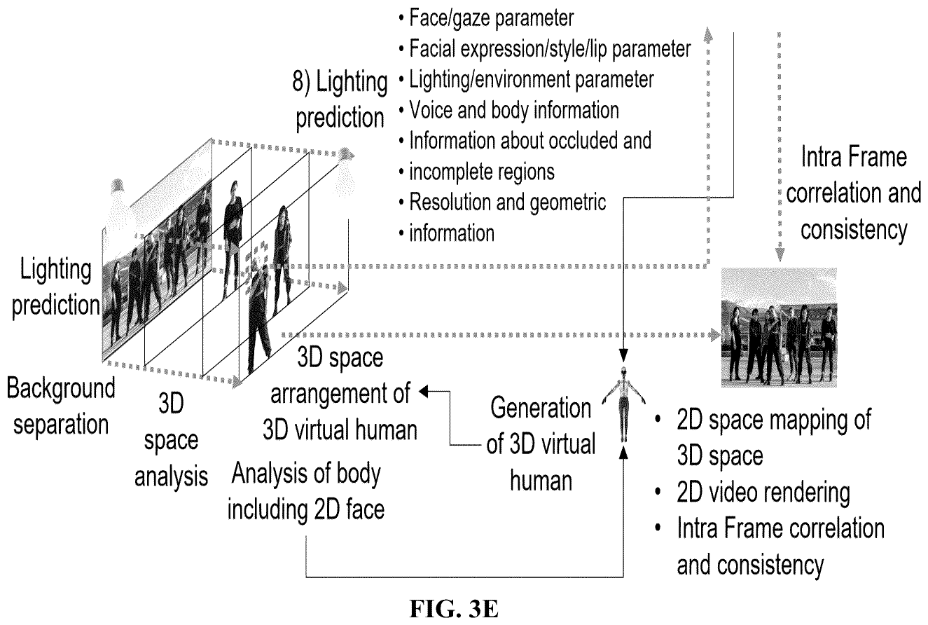

Next, the method for editing performers in a video using a virtual human according to one embodiment of the present invention will be described with reference to FIGS. 2 and 3A-3E.

FIG. 2 is a flowchart explaining the method for editing performers in a video using a virtual human according to one embodiment of the present invention. FIG. 3A to FIG. 3E are diagrams illustrating a process of the method for editing performers in a video using a virtual human according to one embodiment of the present invention.

The method according to the present invention uses an input video analysis technology for applying 2D/3D face model animation, a 3D face tracking technology applicable to various real-captured input images which move fast, a 2D and 3D face optimization and facial expression deformation technology for synthesizing a high-quality realistic image, and an operation technology of a 3D digital human based on scene analysis of a 2D image.

First, as illustrated in FIG. 2, a two-dimensional (2D) moving image or video is received, the video is searched in frame units, and frames including a performer or person (source human object) of an editing target are selected (extracted) (S10).

The editing target is a performer or person appearing in a 2D moving image or video, which is referred to as a source human object.

The input 2D moving image or video is composed of a plurality of consecutive frames.

In addition, preferably, the 2D video includes audio. For example, like a video such as YouTube, a 2D video receives audio data of a voice in addition to the image.

Meanwhile, the extracted (selected) frame is referred to as a frame of an editing target.

That is, frames including the performer or person of the editing target (or the source human object) are searched for, so that the number of frames is recorded and managed for each person (or performer). The performer or person of the editing target is a person to be edited (or replaced). The performer or person of the editing target is set in advance.

Preferably, the frame including the performer or person is searched for and selected by using an object detection model of deep learning [Non-Patent Document 1].

Preferably, the audio data of the 2D video is analyzed to identify the performer or person of the editing target. That is, a voice of the performer or person is identified through voice recognition or voice analysis. In this case, preferably, a specific person is identified through a voice using an artificial intelligence technique such as deep learning. It is possible to increase the accuracy by determining individual voice information included in a sound using artificial intelligence.

In particular, there is a possibility that a section (time section) in which a voice of the editing target appears in the audio data is detected, and the corresponding performer or person may appear in a video image frame within the detected time section.

In this case, a specific person or performer may be identified from among a limited number of persons by using information about characters of a script book owned in advance. Accordingly, the accuracy of the determination may be enhanced.

In addition, when the number of editing targets (or characters, source human objects) is 2 or more, a frame in which the corresponding editing target appears is selected (extracted) for each editing target. Accordingly, it can be seen that which editing target (or character) appears for each frame.

Next, a face of the editing target (source human object) is recognized and tracked using an object tracking method within the extracted (selected) frame (S20). That is, a face sequence of the editing target (source human object) is recognized and tracked by reflecting a face position of the previous and subsequent frames for the consecutive frames. For example, the face position in the current frame is located within a certain range (a range of a moving speed) of the face position within the previous frame.

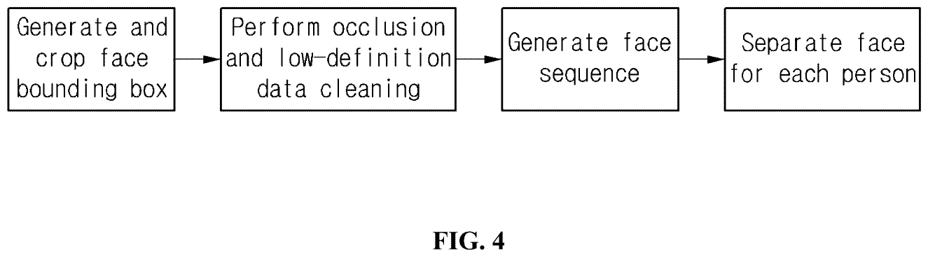

FIG. 4 illustrates a detailed process for a step of recognizing and tracking the face.

Face recognition within one frame utilizes a deep learning-based face detection method. That is, a bounding box of the face in the image is generated and cropped through a face detection technique based on deep learning (for example, Retina Face) [Non-Patent Document 2]. In addition, deep learning (for example, RTNet [Non-Patent Document 3])-based occlusion and low-definition data filtering are performed.

Next, a face sequence for each person (editing target, source human object) is generated from the face extraction result in the image. That is, faces of a specific person (or editing target) extracted from each of the consecutive frames are composed of a sequence. In particular, in the case of a plurality of persons (editing targets, source human objects), a face sequence is generated for each person.

Meanwhile, after detecting a scene change through similarity analysis between the adjacent frames, the clip is separated, and a face sequence is generated within a single clip.

Preferably, a deep learning (for example, SORT [Non-Patent Document 4])-based object tracking technique is used to process multiple persons in the frame and to generate the face sequence in a single clip. A face sequence for each person in the entire clip is generated through a face recognition technique based on deep learning (for example, ArcFace [Non-Patent Document 5]). Deep learning may be used to construct such a method, but a software solution that has already produced may also be used.

Next, a depth map is generated to find a location (or depth) in a distance between each object and a background, which constitute a 2D video (or a frame image of an editing target), and a determination is made whether the object is located in front of or rear of a human object (or performer/person object) of the editing target (S30). That is, for each object, it is determined whether the object is located in front of or rear of the human object. In this case, the background is estimated to be located rear of the human object of the editing target.

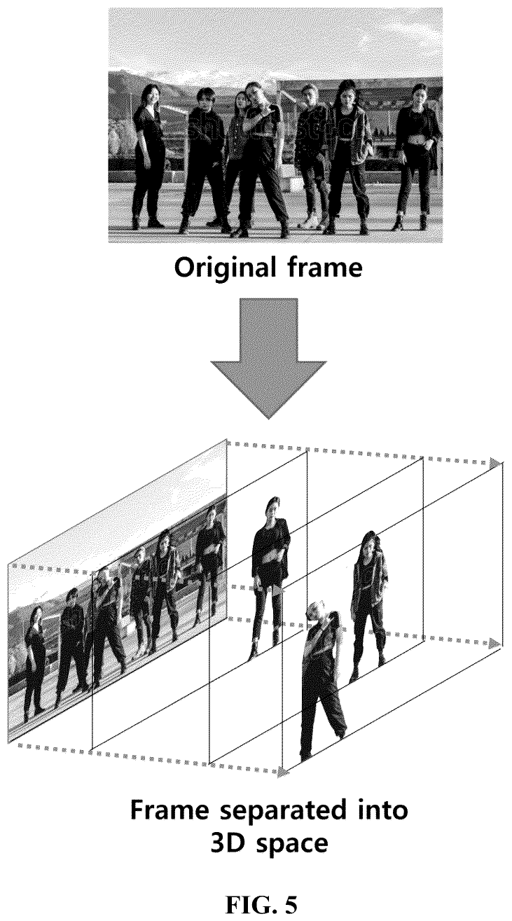

FIG. 5 illustrates a process of mapping each frame of the 2D video to a 3D space.

The depth map is an image including depth information for each pixel, and accordingly, the 2D video may be converted into 3D video. When the 2D video exists, the depth map may be generated by analyzing a motion between the successive frames by using an optical flow technology [Non-Patent Document 6] or a stereo matching technology [Non-Patent Document 7]. In addition, the depth map may be predicted using deep learning technology with deep neural networks.

The depth map only needs to clearly distinguish the front and rear positions of an object to be edited or replaced from other objects or the surrounding environment and background in a distance relationship. Since an object of the present invention is to replace an original 2D person using a 3D virtual human and render the 2D image again, it is not necessary to estimate an accurate depth for all pixels in the 2D image. In addition, it is only necessary to confirm a positional relationship that the person to be edited is in front of or rear of other persons, objects, and backgrounds.

That is, depths (distances from the background) of the human object of the editing target and other objects in the corresponding frame or image is estimated, and it is determined that the object is located rear of the human object when the depth of the object is deeper than the depth of the human object of the editing target, and the object is located in front of the human object when the depth of the object is not deeper than the depth of the human object.

The object separated according to the depth is classified into a background object, a human object of the editing target (source human object), and a general object. The background object is an object located at the rearmost (deepest) side, and corresponds to a background of a typical 2D video. The source human object is a human object that is the editing target. The general object is an object other than the human object of the editing target, and may be a typical object such as a table or an object that is not an object of the editing target even if the general object is the human object.

Meanwhile, preferably, all objects located rear of (located deeper than) the human object that is located at the rearmost side among source human objects of the editing target are integrated (synthesized) into the background object.

Preferably, the corresponding step is also performed for each frame unit of each editing target. Alternatively, as another embodiment, the frame may be classified into a key frame and an intermediate frame so that the corresponding operation may be performed in the key frame, and the intermediate frame may reflect the result of the key frame without performing the corresponding operation.

Next, a 3D face template that is most suitable for the face of the editing target (source human object) is selected, and a 3D face (or a conversion/target model 3D face) of the corresponding person to be converted is generated from the selected 3D face template (S40).

Preferably, the face may be separated for each person and a 3D face template most suitable for each person may be generated. That is, the 3D face template is classified and set according to a plurality of attributes, and a 3D face template of an attribute classification corresponding to an attribute belonging to the corresponding person is selected. For example, the 3D face template may be classified according to a plurality of attributes such as an age group (unit of 10 years old), Asian/Western, male/female, and presence/absence of double eyelids.

Alternatively, as another embodiment, a 3D face template for each person may be set in advance.

Meanwhile, in this case, there are two or more editing targets (source human objects). In this case, a virtual human for each person is generated and edited, and the edited 3D virtual human is projected onto the 2D video image.

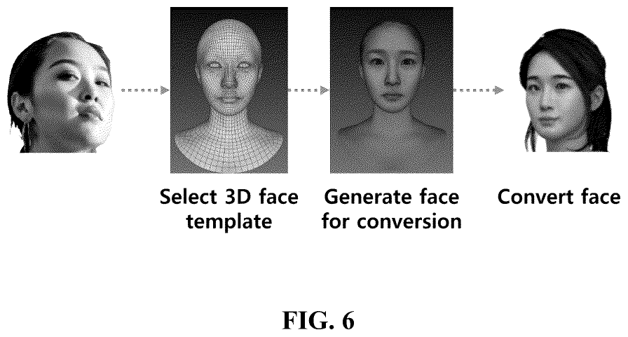

FIG. 6 is a diagram illustrating a process of generating a face for conversion (the face of the target human object) from a result of separating the face of the editing target.

The face to be converted (the face of the target model) may be a face of the editing target person or may be different from the face of the editing target person. When the editing target person is replaced with another person, the face to be converted and face of the editing target are different from each other. In this case, a target to be converted is referred to as a target model or a target human object. Therefore, the face for conversion means a face of the target model (target human object).

A 3D face template of the target model is a standardized and databased 3D face template. A 3D face for conversion (a 3D face of the target model) is generated by reflecting the 2D face of the conversion target (the target model) in the 3D face template of the target model. In this case, an artificial intelligence technique [Non-Patent Document 8] may be used, or conventional software [Non-Patent Document 9] may be used.

In addition, the 3D face of the target model is synchronized to a position of a 3D face of a source model.

Specifically, the 3D face (3D face template) of the target model is moved to the position of the source model in the 3D space. Next, the overall size of the 3D face (3D face template) of the target model is adjusted to a similar size to that of the source model (original model, original face). Next, landmarks such as an area around the eyes, an area around the mouth, the jawline, and the nose line are set in the two models. The 3D face (3D face template) of the target model is deformed such that the landmark of the 3D face (3D face template) of the target model overlaps the landmark of the face (original face) of the source model (the position overlaps the direction). Preferably, after the two models are aligned based on the tip of the nose, the 3D face (3D face template) of the target model is deformed so that the landmarks overlap each other.

Although the deformation of the position of the 3D face in which the target face is reflected has been described, in this case, a 3D structure of the 3D face refers to a deformation of a structure of the 3D face template.

In particular, the direction and the gaze of the original face are analyzed to convert the 3D face (3D face template) of the target model into the form similar to the original face. That is, the direction and the gaze of the 3D face for conversion are converted into the form similar to the original face.

Specifically, after major feature points (or landmarks) of the eyes, the nose, the mouth, and the like are detected from the face, relative positions thereof are analyzed to estimate a face direction. For example, a rotation angle may be calculated using a center line of the face and a position of the eyes. In addition, the position of the pupils in the eyes is determined to estimate the direction of the gaze together with the face direction.

In this case, the accurate direction may be updated by comparing the previously stored 3D face template with the major feature points.

Preferably, the corresponding step is also performed for each frame unit of each editing target. Alternatively, as another embodiment, the frame may be classified into a key frame and an intermediate frame so that the corresponding operation may be performed in the key frame, and the intermediate frame may be corrected by correcting only the position such as the direction and the gaze from the result of the key frame without performing all the corresponding operations, or by interpolation or the like.

Next, lighting information is estimated from the input 2D video.

That is, the lighting information, that is, a light source position, a light intensity, and the like, is estimated for the 2D video or the frame of the editing target.

In particular, the 3D face is naturally synthesized with the entire contents of the 2D video in consideration of environmental factors (motion and characteristics of the light source) analyzed in the 2D video. That is, the lighting information needs to be estimated to reflect the (estimated) lighting information in the 3D face or the edited virtual human, and the lighting information needs to be synthesized in the 2D video or frame.

In each step, a depth map, lighting information, and the like are all obtained for each frame unit.

Meanwhile, in this case, lighting estimation is used. The lighting estimation technology is a technology for estimating a light source position and a lighting intensity in the 2D video and image, and includes a physics-based method, a computer vision method, a deep learning method, and the like.

The deep learning method is a method for estimating lighting information from an image using a deep learning network, and the network may accurately estimate even under complex lighting conditions by learning the lighting information in pixel units of the image.

The physics-based rendering (PBR) method simulates an interaction between lighting and materials based on the laws of physics. This method may reproduce an actual lighting effect in consideration of physical characteristics such as reflection, refraction, and diffusion of lighting, and may perform more accurate lighting estimation through the reproduction.

The inverse rendering method starts from a final image and inversely estimates lighting conditions and materials of an object. The inverse rendering method is a method for estimating a lighting environment by combining data obtained from the image with a physics-based model, and is useful in 3D reconstruction and augmented reality.

Preferably, the corresponding step is also performed for each frame unit of each editing target. Alternatively, as another embodiment, the frame may be classified into a key frame and an intermediate frame so that the corresponding operation may be performed in the key frame, and the intermediate frame may correct the lighting information (the direction, the position, the intensity, and the like) of the key frame by interpolation or the like without performing all the corresponding operations.

Next, pose information is estimated from the human object (or the performer/person object) of the editing target in the 2D video, and a virtual human of the target model is generated (S60).

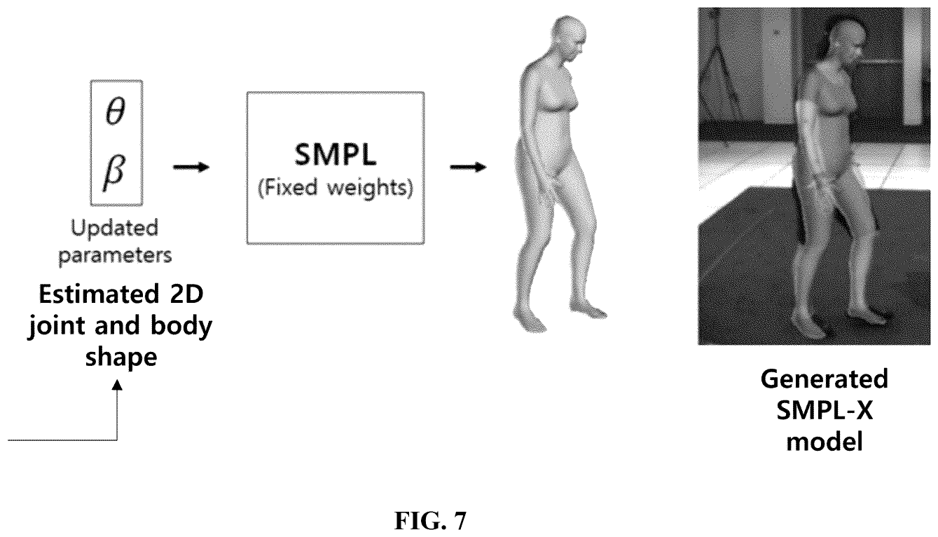

FIG. 7 is a diagram illustrating a process of generating a virtual human.

That is, a pose is estimated from the human object of the editing target in the 2D video or frame, and a virtual human is generated by reflecting the estimated pose in the 3D body template (or the target model).

The 3D body template of the target model is prepared in advance for editing the 2D video. Preferably, the 3D body template of the target model is configured in a skinned multi-person linear model-eXpresive (SMPL-X) format. The 3D body template or target model is a model in which clothing and the like has been already set up to replace a person in the 2D video.

Joint and skeleton information is extracted from a 2D image separated into the 3D space, particularly, a specific person, using a 2D pose estimation algorithm. The joint and skeleton information is converted into a SMPL-X parameter and includes all of the full body, fingers, and the position of the face. The 3D body template of the target model is converted using the extracted SMPL-X parameter.

The SMPL-X model estimates an outer appearance of the body in addition to the joint and skeleton information from the 2D image. Accordingly, the 3D body converted for the editing may almost identically follow the outer appearance of the person in the 2D video. That is, the 3D body converted for the editing may replace the person in the original 2D video.

Meanwhile, the SMPL-X deep learning model has a 3D body template prepared therein. That is, the SMPL-X deep learning model uses the 3D body template prepared in advance and applies artificial intelligence to estimate and generate a 3D body.

Preferably, according to the present invention, the estimating of the skeleton information and the outer appearance may be separated. That is, a virtual human of the target model may be generated from the 3D body template by estimating a pose such as 3D skeleton information and the like in the frame of the 2D video, and an outer appearance may be generated (edited) by rendering the virtual human of the target model by extracting a texture and the like from an image of the 2D video.

In this case, 3D clothing may be fitted to the 3D body template by pose estimation. That is, the virtual human of the target model is generated by putting new clothes, accessories, shoes, and the like on the 3D body template by pose estimation.

In addition, the face for conversion (or the face of the 3D target model) obtained in step S40 is synthesized prior to the virtual human of the generated target model to finally generate the virtual human of the target model.

Preferably, the corresponding step is also performed for each frame unit of each editing target. Alternatively, as another embodiment, the frame may be classified into a key frame and an intermediate frame so that the corresponding operation may be performed in the key frame, and the intermediate frame may correct the virtual human of the key frame by interpolation or the like without performing all the corresponding operations.

In particular, the pose information (skeleton information and the like) of the virtual human may be corrected by interpolation or the like to generate a virtual human of the corresponding intermediate frame. In this case, after a rigging operation is performed on the virtual human, pose information (skeleton/joint positions) is corrected by interpolation, and a pose of the virtual human is changed according to the corrected pose information to generate the virtual human of the corresponding frame.

Meanwhile, the pose is corrected to secure correlation and consistency between the frames.

That is, information estimated in frame units may not secure continuity between the frames. This may be due to imperfections in the technology of estimating the 2D image and imperfections in the information of the person included in the 2D image. The person in the 2D video may not make a sudden movement or change beyond a threshold until a scene change occurs.

Accordingly, in order to guarantee a continuous and consistent motion of a person between the frames, motion information that abnormally emerges after inspecting the continuity is corrected by considering the pose information estimated from temporally previous and subsequent frames in addition to the estimated pose information.

In general, when coordinates are rapidly changed by examining the coordinates for each frame on a time axis for each joint, pose information such as abnormal joint coordinates of the corresponding frame may be corrected by referring to the previous and subsequent frames. Upon modification, a simple interpolation function or a bicubic filter may be used.

Next, the virtual human of the target model is edited (S70).

That is, for a specific section of the frame, the virtual human of the target model is animated according to a preset pose sequence to generate a virtual human of each frame.

For example, when it is assumed that the specific section is from frames k+1 to k+n, a pose sequence for the corresponding section is set in advance. The pose sequence is a series of 3D pose data, and includes of a series of n pieces of pose data corresponding to the frames k+1 to k+n.

Preferably, the pose data of the SMPL model is used when rigging is performed on the virtual human of the target model. When the skeleton of the SMPL-X is rigged in the newly generated virtual human, a 3D model having an animatable SMPL-X skeleton structure is finally generated.

The virtual human generated in the frame k is rigged, and the pose of the rigged virtual human is edited by reflecting the pose sequence.

In particular, the virtual human is animated by reflecting a sequence of 3D poses using motion retargeting. The motion retargeting is performed by reflecting the 3D pose sequence. The motion retargeting is a technology of applying motion data of one character to another character. That is, since the sequence of the 3D pose is the 3D motion data, the sequence of the 3D pose may be applied to a 3D virtual human to animate the sequence.

A virtual human of each frame is generated from the animated virtual human in the sections of the frames k+1 to k+n.

Accordingly, in the sections of the frames k+1 to k+n, a video image may be edited with a motion different from the motion of the editing target (source human object) in the original video image.

Meanwhile, preferably, the last pose of the pose sequence, that is, the pose of the frame k+n is set to be the same as the pose of the next frame k+n+1 or to be located within a predetermined range. This is to allow continuous images of the video image to operate naturally.

Next, the separate background or 2D background image is corrected (S80).

In the original 2D video, a region in which the human object of the editing target is separated and a region of an object of a newly inserted target model may not match each other. In particular, when the object region of the target model is not inserted into the separated region, the corresponding space remains as an empty space. Alternatively, when a person to be changed is smaller than the original 2D person, an additional complementary process is required.

Therefore, for such a case, a region in which the human object is separated from the 2D background image or a part thereof is corrected. Preferably, a region of the empty space is estimated and corrected using a deep learning method. A method for estimating and correcting a region of an empty space uses the related art [Non-Patent Documents 10 and 11].

That is, after a region in which there is no pixel of the background due to the separation of the person in the separated 3D space is filled or reduced using a deep learning technology or the like, a new 3D model smaller than the original 2D person may be located.

Meanwhile, preferably, the background video or the background image is generated as an image including both a background image and an image of the object located rear of the human object of the editing target, thereby correcting the corresponding background image.

Next, the generated virtual human is synthesized into a space of the 2D video.

In order to replace the deformed 3D virtual human, the deformed 3D virtual human is disposed at a position, and the 3D space is rendered into a 2D space in an orthogonal manner to generate a 2D image. The projection method includes an orthogonal method and a perspective method. The orthogonal method is a method for linearly projecting an object and a background without applying the perspective method at all [Non-Patent Document 12].

In particular, the outer appearance of the virtual human is rendered by reflecting the previously obtained lighting information, and the rendered 3D virtual human is synthesized by projecting the rendered 3D virtual human onto a 2D plane.

In addition, the objects separated in advance are projected (synthesized) onto the 2D video image space, respectively, in which the objects are sequentially projected onto the 2D video image space from the rearmost object according to a front-rear positional relationship and synthesized. The background object, the general object, and the virtual human of the target human object are sequentially projected (synthesized) onto the 2D space according to the original depth of the angle. In this case, the 2D image projected (synthesized) later is projected (synthesized) while covering the projected 2D image.

In this case, the rearmost object is a background. The background object is projected to the previously corrected background. In addition, the general object is projected (synthesized) into the 2D space as it is the original 2D object. That is, when the object separated in advance is not the source human object of the editing target, but the general object, the separated object is synthesized into the 2D video image as it is in a 2D image state.

In addition, the virtual human of the target human object is projected (synthesized) in an order according to the depth of the corresponding source human object.

When two or more source human objects are separated from each other, virtual humans of target human objects corresponding to the source human objects are projected (synthesized) onto the 2D image, respectively, and are sequentially projected according to the depth (front and rear position). That is, a virtual human located at the rearmost side (the deepest side) is projected first, and a virtual human located sequentially at the rear side is projected. In this way, the virtual humans are sequentially projected from the virtual human located at the deep (rear) side.

Although the present invention invented by the present inventor has been described in detail with reference to the embodiments, the present invention is not limited to the above embodiments, and various modifications are possible without departing from the scope and spirit of the present invention.

What is claimed is:

1. A method for editing performers in a video using a virtual human, the method comprising:
(a) selecting frames including a person of a human object to be edited (hereinafter referred to as a source human object) by searching for a 2D video composed of a plurality of consecutive frames in frame units;
(b) generating a face sequence of the source human object by tracking a face of the source human object in the selected frames;
(c) finding a depth of each object existing in a corresponding frame by generating a depth map, and determining whether a corresponding object is located in front of or rear of the source human object;
(d) selecting a 3D face template for the face of the source human object, and generating a 3D face of a target human object by reflecting a 2D face of the target human object in the selected 3D face template;
(f) estimating pose information from the source human object for each of the selected frames, generating a 3D virtual human of the target human object by reflecting the pose information in a preset 3D body template, and synthesizing the 3D face of the target human object with a face portion of the 3D virtual human of the target human object; and
(i) synthesizing the 3D virtual human of the target human object into a 2D video image space of the corresponding frame.

2. The method of claim 1, wherein, in step (c), the object separated according to the depth is composed of a background object located at a rearmost side, a source human object that is an editing target, and a general object that is neither the background object nor the source human object, and
in step (i), each separated object is synthesized into the 2D video space, in which the separated object is sequentially synthesized into the 2D video space from an object that is located at the rearmost side according to a front-rear positional relationship, and when the separated object is the general object, the general object is synthesized into the 2D video space as it is, and when the separated object is the source human object, a virtual human of a target human object corresponding to the source human object is synthesized into the 2D video space.

3. The method of claim 2, wherein in step (c), all general objects located rear of a human object that is located at the rearmost side among source human objects of the editing target are integrated into the background object.

4. The method of claim 1, further comprising (h) correcting a separated background object in association with a region of the separated object,
wherein, in step (i), when each separated object is synthesized into the 2D video space, the corrected background is synthesized instead of the separated background object, and is first synthesized into the 2D video space.

5. The method of claim 1, wherein, in step (d), a 3D face template corresponding to the face of the source human object is selected, a 3D face of the target human object is generated by reflecting the 2D face of the target human object in the 3D face template, and a position and a direction of the 3D face of the target human object are synchronized with a size, a position, and a direction of the 2D face of the source human object.

6. The method of claim 5, wherein, in step (d), the 3D face of the target human object and the 2D face of the source human object are synchronized to coincide with each other in terms of the position and the direction using landmarks including at least one of an area around eyes, an area around a mouth, a jawline, and a nose line.

7. The method of claim 1, further comprising (e) estimating lighting information including a light source position and a lighting intensity with respect to each of the selected frames,
wherein, in step (i), an outer appearance of the 3D virtual human of the target human object is rendered by reflecting the estimated lighting information, and the rendered 3D virtual human is synthesized by projecting the rendered 3D virtual human onto a 2D plane.

8. The method of claim 1, wherein, in step (f), the 3D virtual human of the target human object is generated from a 2D image of a corresponding frame of the 2D video, in which the 3D virtual human of the target human object is generated using a skinned multi-person linear model-eXpretive (SMPL-X) deep learning model, and pose information and an outer appearance of the 3D virtual human are extracted.

9. The method of claim 1, further comprising (g) animating a 3D virtual human of the target human object according to a preset pose sequence for sections of frames k+1 to k+n to generate a 3D virtual human of each frame by rigging the 3D virtual human of a frame k and reflecting and the pose sequence in the rigged 3D virtual human,
wherein, in step (i), the 3D virtual human generated by animating in step (g) is synthesized into a 2D video space.

10. A computer-readable recording medium having a program recorded thereon for executing the method for editing the performers in the video using the virtual human of claim 1.

11. A computer-readable recording medium having a program recorded thereon for executing the method for editing the performers in the video using the virtual human of claim 2.

12. A computer-readable recording medium having a program recorded thereon for executing the method for editing the performers in the video using the virtual human of claim 3.

13. A computer-readable recording medium having a program recorded thereon for executing the method for editing the performers in the video using the virtual human of claim 4.

14. A computer-readable recording medium having a program recorded thereon for executing the method for editing the performers in the video using the virtual human of claim 5.

15. A computer-readable recording medium having a program recorded thereon for executing the method for editing the performers in the video using the virtual human of claim 6.

16. A computer-readable recording medium having a program recorded thereon for executing the method for editing the performers in the video using the virtual human of claim 7.

17. A computer-readable recording medium having a program recorded thereon for executing the method for editing the performers in the video using the virtual human of claim 8.

18. A computer-readable recording medium having a program recorded thereon for executing the method for editing the performers in the video using the virtual human of claim 9.
